(19) United States
(12) Patent Application Publication
(10) Pub. No.: US 2026/0290297 A1
(43) Pub. Date: Sep. 24, 2026

(54) IMPROVEMENTS IN OR RELATING TO WHISTLES

(71) Applicant: J HUDSON & CO (WHISTLES) LIMITED, Birmingham, West Midlands (GB)

(72) Inventor: Benjamin Andrew Iain McFARLANE, Burton Upon Trent (GB)

(73) Assignee: J HUDSON & CO (WHISTLES) LIMITED, Birmingham, West Midlands (GB)

(21) Appl. No.: 19/168,931

(22) PCT Filed: Mar. 7, 2024
(86) PCT No.: PCT/GB2024/000011

§ 371 Date: Sep. 25, 2025

(30) Foreign Application Priority Data
Mar. 27, 2023 (GB) 2304441.5

(51) Int. Cl. G10K 5/00; A01K 15/02

(52) U.S. Cl. CPC G10K 5/00; A01K 15/02

(57) ABSTRACT

FIG. 1 shows a whistle (1) of a generally known exterior shape being virtually identical to the shape of the Applicant company's ACME 210 ½ whistle. Even so, the outward appearance of the whistle (1) is substantially very different to the known ACME 210 ½ whistle and the internal structure is very different. Whistle (1) has a polycarbonate framework or structure (2) onto which is injected moulded an elastomeric material covering or coating (3) (such as neoprene rubber or like). The structure (2) comprises upper and lower polycarbonate components that are assembled together prior to the coating (3) being applied. Parts of the internal structure (2) remain exposed in the completed whistle (1).

### FIELD

This invention relates to improvements in or relating to whistles and is more particularly but not exclusively concerned with dog whistles.

### BACKGROUND

The Applicant is a very well-known venerable company possessing an extensive knowledge of manufacturing whistles gleaned over an impressive one hundred and fifty year period. Even so, the inventor recognises that, even today, all the operating parameters for producing optimised designs may not have been maximised and that there still tend to be a number of problems associated with existing designs and their manufacture that could be overcome or alleviated.

The Applicant has addressed some of the problems associated with the design of dog whistles in their Patent Specification No. EP 0930 605 B1, the content of which is referred to the reader. In that Patent Specification, the inventor has recognised the criticality of the shape and dimensions of the sound chamber in order to avoid stalling of the whistle whilst restricting variation of the frequency as the blowing pressure is varied to within a narrow frequency bandwidth.

Nevertheless, there still tend to be problems often encountered with these whistles (and evolved versions of same) which have lacked a solution for a very considerable period of time.

The dog whistles as shown in Patent Specification No. EP0930605B1 are constructed in two parts which are ultrasonically welded together to form the sound chamber and mouthpiece. The design necessitates pegs being formed on one part which fit into receiving holes on the other part to connect them together. Disadvantageously, any small gaps in the weld lines between the two parts along the sound chamber can provide an outlet for air blown into the sound chamber. On blowing the whistle, any emerging or escaping air from the weld lines along the sound chamber may create secondary sounds which could be confusing for a dog listening to whistle commands, as these secondary sounds could be perceived by the dog as belonging to another whistle. These secondary sounds are typically in the form of a ‘hiss’ produced alongside the basic sound of the whistle. Furthermore, such secondary sounds may, in any event, be created by air passing through the air vent at or over the corners of the cutting or splitter edge.

Thus, it poses a problem that the sound chambers of current dog whistles invariably tend to be unable to capture and use all of the air blown into the whistle in an efficient manner without some leakage of air occurring.

Still further, disadvantageously, when blowing into the whistle, it is possible that air may leak from gaps in the weld lines along the mouthpiece also creating similar, undesirable, secondary sounds.

Once again, owing to the mouthpiece design, it is possible that air intended to be blown into the mouthpiece by the user is simply lost or leaked around the outer surface of the mouthpiece possibly without ever entering the mouthpiece; once again leading to a loss of efficient use of air provided by the user.

Clearly, any inconsistency in the sound produced by the whistle away from what is intended and easily reproducible by the user can produce problems in training or controlling a dog through command signals from the whistle. As is well known, dogs have acute hearing and so quite small variations in sound (that a user or dog trainer may not even hear or be aware of) may be perceived by the dog, potentially leading to a detrimental or confusing result or action by the dog. Of course, this would be a critical factor in dogs' trials where there is a heavy dependency on accurate whistle command signals being given in a timely fashion to enable the dog to carry out assigned tasks swiftly. Inaccurate or confusing whistle command signals could lead to confusion for the dog and a complete failure for the dog to recognise the command being given.

Furthermore, dog whistles need to be capable of readily being blown to produce not only a fundamental frequency but, within that frequency, loud and quiet notes with the length of those notes being variable. Effectively, good dog trainers ‘talk’ to their dogs using their whistle and their ‘voice’ (or style of whistling) is readily recognisable as being unique to their dog.

Dog training has become more and more popular with an accompanying greater sophistication of training techniques. Whistles are undoubtedly a major feature of this training and the need for more sophisticated, reliable, stable and consistent sounding whistles to achieve better communication between trainers and dogs is becoming ever more apparent.

Accordingly, it is believed that whistles, and dog whistles in particular, can be improved to alleviate or obviate secondary sounds that may originate from the sound chamber and/or from or around the mouthpiece. Further, it is believed that whistles, and in particular dog whistles, can be improved to be more efficient in using air blown into or intended to be blown into the whistle by the user.

The Applicant believes that capturing all the air blown into a whistle and converting it into sound efficiently emitted via the air vent should have two main beneficial effects. Firstly, any secondary sounds as previously discussed should not occur. Secondly, and most advantageously, sound should be able to be created by extremely gentle, even seemingly effortless, blowing into the whistle (akin to merely breathing into the whistle). This should enable a dog whistle to be blown so quietly that it is almost inaudible to a human ear, to provide the user with a far greater degree of control over the sound produced e.g. increasing the loudness of the sound in small increments of breath creating an easily reproducible and consistent range of sound that a trained dog can respond to reliably with confidence.

It would be highly beneficial to a user to be able to issue whistle signal commands to a dog using seemingly minimum effort and breath as the situation may require a large or repetitive amount of command signals to be given which may otherwise be tedious if considerable effort and ‘puff’ is necessitated on each command signal occasion.

In addition to the expressed problems about the undesirable generation of secondary sounds, the Applicant is also concerned with improving the comfort of the user more particularly when handling the whistle and when blowing into the mouthpiece.

If the mouth is not seated comfortably on the mouthpiece when blowing, air intended to be blown into the mouthpiece may instead escape around the outside, and/or bounce out, of the mouthpiece.

Furthermore, owing to the material used for the whistle e.g. polycarbonate material (more particularly for the mouthpiece) the temperature and texture of the whistle may not be conducive to comfortable handling or mouth/teeth contact, more particularly in cold and/or wet weather.

Accordingly, it has been proposed to provide a cushioned layer of elastomeric material to the mouthpiece so as to soften the mouthpiece and minimize any impact between the whistle mouthpiece and the teeth in order to increase comfort for the user (see e.g. Patent Specification No. GB2393317B).

Even though Patent Specification No. GB2393317B seeks to provide a more comfortable mouth grip for the user it is believed to have certain disadvantages. Firstly, the cushioned layer only covers the mouthpiece and does not provide a complete comfort in handling the whistle. The cushioned layer only covers the mouthpiece and thus may not alleviate secondary sounds that may be caused by air leaking from the sound chamber. Furthermore, the material for the cushioned layer is said to be a soft elastomeric material or other synthetic rubber like material moulded in situ on the mouthpiece, which seemingly may be subject to peeling off the mouthpiece and/or deterioration over time. Disadvantageously, the cushioned layer would appear to a soft, spongy, compressible/deformable (not firm and durable) relatively thick layer necessarily requiring attachment to the whistle via purpose-made projections or nubs to hold the layer to the whistle mouthpiece. The whistle may be subject to other disadvantages and the overall profile of the whistle clearly deviates from the previous model manufactured without the cushioned mouthpiece.

### SUMMARY

Accordingly, it is an object of the present invention to provide a whistle which at least alleviates one or more of the aforementioned, or other, disadvantages or to provide a whistle which is improved in at least some respect.

According to one aspect of the present invention there is provided a whistle comprising component parts that can be brought or joined together to define a whistle sound chamber with an air vent and a mouthpiece, the sound chamber and mouthpiece being substantially covered or coated by an elastomeric material.

Further according to this aspect of the present invention there is provided a method of making a whistle comprising bringing or joining together component parts to define a whistle sound chamber with an air vent and a mouthpiece and substantially covering or coating the sound chamber and mouthpiece by an elastomeric material.

Usually, two component parts will be provided to define the sound chamber and mouthpiece.

The component parts will usually be assembled together to form a structure or framework or skeleton on which the elastomeric material can be injection moulded.

To assemble the two component parts together two projecting (part-circular) plates may be provided on a first one of said parts (preferably at the end of the sound chamber) engageable with a plate on the other part arranged between said first mentioned plates; one of said two projecting plates may be provided with a slot receiving a longitudinal or backbone member of the other part. Said other part may be provided with a series of rib plates extending transversely of the backbone member; the edges of said rib plates may be exposed in the finished whistle.

Advantageously, longitudinal edges of said first one of the parts may seat together with edges of the other part in contiguous fashion to define the sound chamber and mouthpiece but without any necessity for secure, snap-fit locking together of parts.

The elastomeric material will usually be selected to seal the join or connection between the component parts obviating any need for adhesive or welding. The seal may provide a mechanical and/or chemical bonding.

Preferably, the elastomeric coating extends substantially along the handling length of the whistle.

Preferably, the elastomeric material selected will prevent any peeling away from the framework.

The elastomeric material may be configured to have enhanced grip characteristics for handling the whistle, preferably provided by raised pips/protrusions, preferably on the underside of the whistle.

Importantly, in one embodiment of the whistle, the angle of the cutting or splitter edge of the air vent may be 43°+/−3° and/or the angle of the air inlet (air directing input channel or ramp) may be about 4°.

A corner of an inner end of the ramp may be right-angled, radiused or angled (example at 45°) in order to improve sound quality.

Further according to the present invention there is provided a whistle having one or more of any of the features derivable from this description and drawings.

Thus, more generally according to the present invention there is provided a whistle having an elastomeric coating or covering around at least a mouthpiece and sound chamber of the whistle.

Further according to the present invention there is provided a whistle having one or more of the following:
a) An elastomeric coating or covering extending over the mouthpiece and sound chamber,
b) A coating as in a) extending substantially along the handling length of the whistle
c) An elastomeric material covering the join between two component parts of the whistle, said component parts preferably together defining a sound chamber and mouthpiece,
d) A non-peelable elastomeric material on a mouthpiece, and preferably on a sound chamber of the whistle, preferably extending along the length of the whistle
e) Two component parts joined together and covered by an elastomeric material
f) Two component parts joined together to define a whistle chamber and mouthpiece, the join between the parts extending significantly less than the length of the whistle e.g. about half the length +/−20% of the whistle length or possibly not beyond the limits of the sound chamber.
g) A whistle air vent splitter edge angle of about 43°+/−3°
h) A whistle air directing input channel (ramp angle) of about 4° or 4.5°
i) A (cylindrical) sound chamber having right angle corners in sectional view
j) An elastomeric coating or application of a material indicated by the trade mark SANTOPRENE
k) An elastomeric material having enhanced grip characteristics, preferably provided by raised pips/protrusions, preferably on the underside of the whistle

Many advantageous features of the whistle will be apparent from the following description and drawings.

### BRIEF DESCRIPTION OF THE FIGURES

Embodiments of a dog whistle, in accordance with the present invention will now be described by way of example only, with reference to the accompanying drawings, in which:

FIGURE A shows a side perspective of a known, current production version of a dog whistle manufactured by the Applicant company;

FIG. 1 shows a top perspective view of a first embodiment of a dog whistle in accordance with the present invention:

FIG. 2 shows an underside perspective view of the whistle shown in FIG. 1 but drawn to a different scale;

FIG. 3 shows a top view of the whistle shown in FIG. 1;

FIG. 4 shows an underside view of the whistle shown in FIG. 1;

FIG. 5 shows a side view of the whistle shown in FIG. 1

FIG. 6 shows an opposite side view of the whistle shown in FIG. 1;

FIG. 7 shows an end view of the whistle shown in FIG. 2 looking in the direction of arrow X;

FIG. 8 shows an end view of the whistle shown in FIG. 2 looking in the direction of arrow Y;

FIGS. 9 and 10 show side perspective and inverted side perspective views of an assembled internal framework or structure of the whistle shown in FIGS. 1 to 8 prior to being subjected to the application of an elastomeric coating or covering;

FIG. 11 shows side views of the separated upper and lower components of the structure shown in FIGS. 9 and 10 together with views of each end of said components;

FIG. 12 shows a plan view of the upper component above an inverted plan view of the lower component;

FIG. 13 shows an inverted plan view of the upper component above a plan view of the lower component;

FIG. 14 shows sectional side views of the separated upper and lower components;

FIG. 15 shows side views of separated upper and lower components of the internal framework or structure of a second embodiment of a dog whistle in accordance with the present invention;

FIG. 16 shows a plan view of the upper component of FIG. 15 above an inverted plan view of the lower component of FIG. 15;

FIG. 17 shows an inverted plan view of the upper component shown in FIG. 15 above a plan view of the lower component shown in FIG. 15;

FIG. 18 shows sectional side views of the separated upper and lower components;

FIG. 19 shows diagrammatically a top view and a sectional side view taken on line DD of the top view of a modified embodiment of a whistle in accordance with the present invention, and

FIG. 20 shows diagrammatically a top view and a sectional side view taken on line CC of a further modified embodiment of a whistle in accordance with the present invention, and

FIGS. 21 and 22 show separately longitudinal sectional views through the known whistle in FIGURE A of upper and lower components.

### DETAILED DESCRIPTION

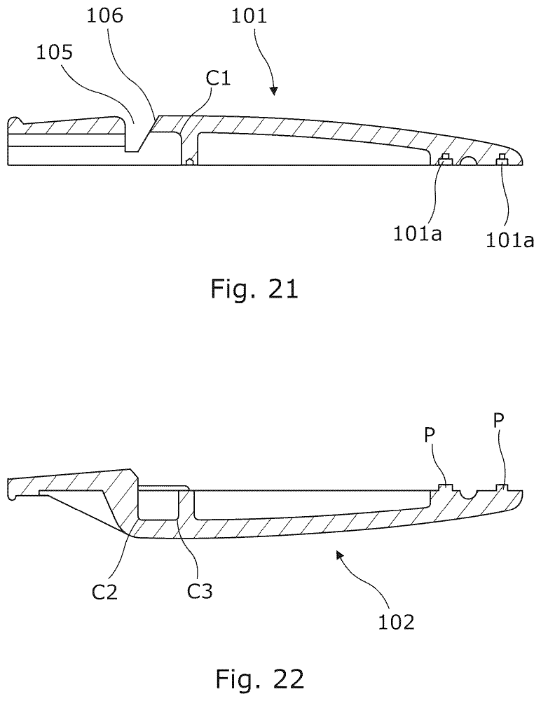

FIGURE A shows a current ACME 2101/2 dog whistle 100 of the Applicant company. ACME is a Registered Trade Mark (UK00901788225) of the Applicant and 2101/2 is a Registered Trade Mark (UK00002652250) of the Applicant. The construction of whistle 100 is generally the same construction as disclosed in Patent Specification No. EP0930605B1 comprising two (upper and lower) longitudinal component parts 101, 102 connected together along the spilt line Z-Z to form a sound chamber 103 and mouthpiece 104. Locating pegs p (not shown in FIGURE A—see FIG. 22) in part 102 are engaged into receiving holes 101a (not shown in FIGURE A—see FIG. 21) in part 101 in a similar manner to that shown in EP0930605B1. The two parts 101 and 102 are secured together by ultrasonic welding along weld line W which extends along the side of whistle 100 as shown, across the open end of mouthpiece 104 and, in parallel fashion to weld line W, along the opposite side of the whistle (not shown) in a manner which should be self-evident.

It tends to be disadvantageous, for example, with the design of whistle 100 shown in FIGURE A, that during manufacture, there could be small air gaps left in weld line W which could give rise to secondary sounds, from air escaping through said gaps, and reduce efficiency, more particularly as herein described earlier on in this patent specification. Furthermore, such secondary sounds may, as previously stated, in any event, possibly be created by air passing through air vent 105 at or over the corners 106a (only one shown) of the cutting or splitter edge 106.

Still further it is believed that the comfort in using the mouth piece 104 and comfort in general handling of the whistle 100 could be improved. In addition, it is believed the design of mouthpiece 104 could be improved to restrain or prevent any initial leakage of air intended to be blown into the mouthpiece. With the design of whistle mouthpiece 104, air supplied by the user may simply be lost or leaked around the outer surface of the mouthpiece possibly without ever entering the mouthpiece; once again leading to a loss of efficient use of air provided by the user. Furthermore, it is believed the design of mouthpiece could be improved in manner more conducive to seating the mouth/teeth more comfortably.

Overall, it is believed that the efficiency and comfort of whistle 100 could be improved in a manner that may capture all, or virtually all, the blown air provided by the user, in particular substantially eliminating secondary sounds in a highly advantageous manner, as previously discussed in this patent specification.

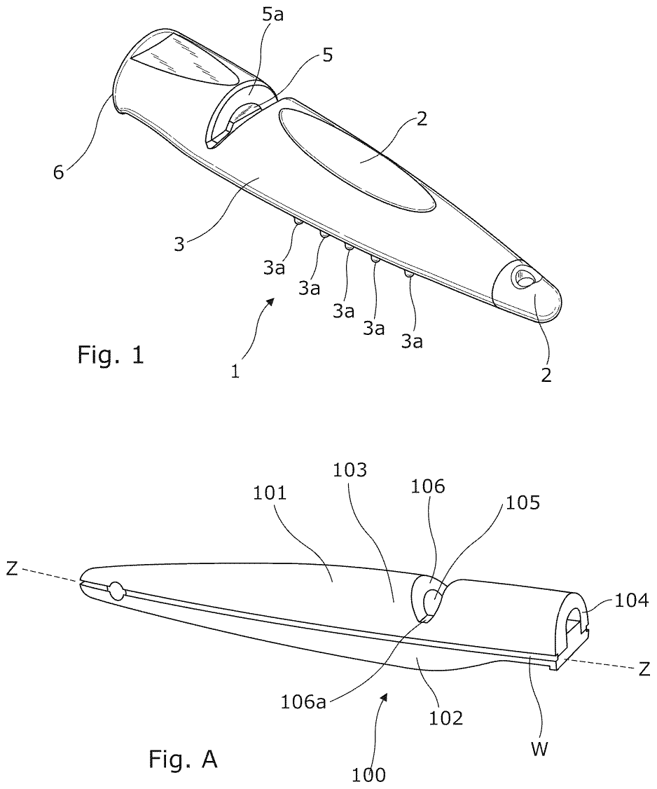

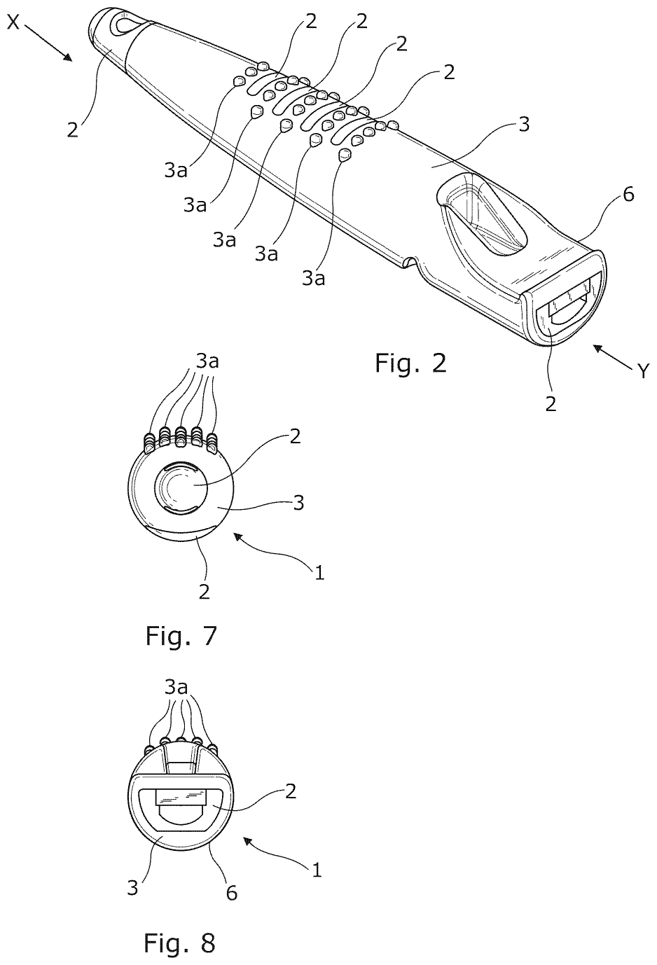

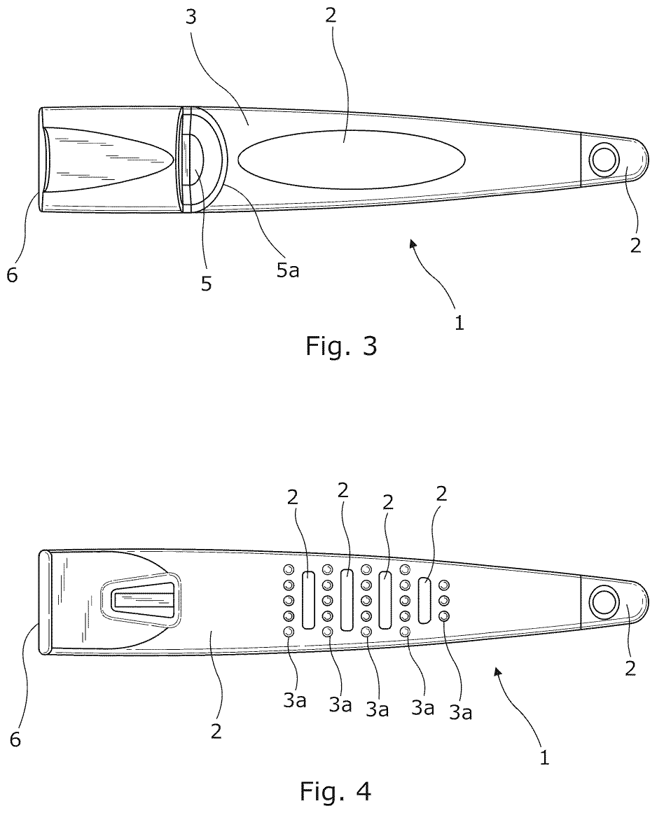

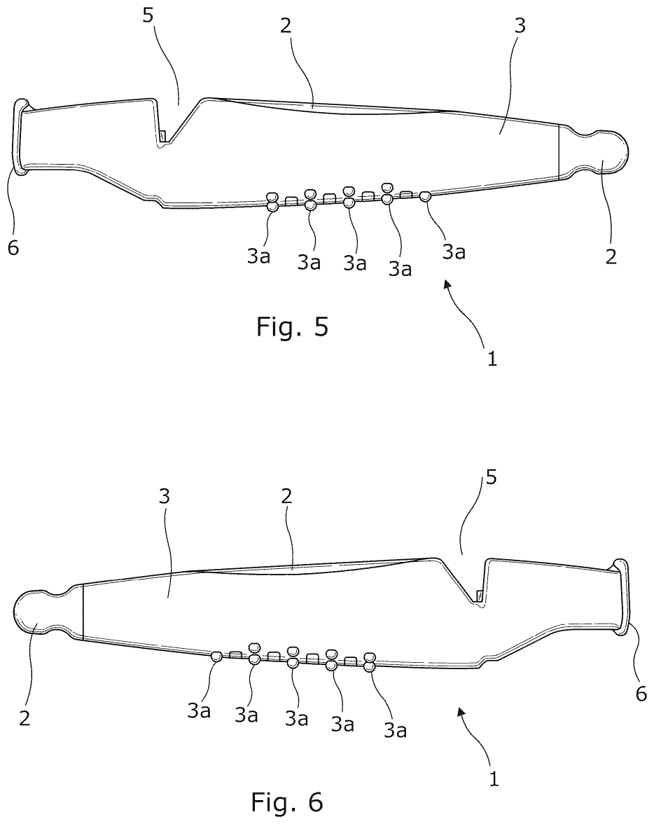

Referring to FIGS. 1 to 8 of the accompanying drawings a first embodiment of a whistle 1, in accordance with the present invention, is generally of a known exterior shape being virtually identical to the shape of the Applicant company's ACME 210 ½ whistle shown in FIGURE A and e.g. on the Applicant's website www.acmewhistles.co.uk

Even so, the outward appearance of the whistle 1 is substantially very different to the known ACME 210 ½ whistle shown on the Applicant's website and the internal structure is very different.

Whistle 1 has a polycarbonate framework or structure 2 onto which is injected moulded an elastomeric material covering or coating 3 (such as neoprene rubber or like)

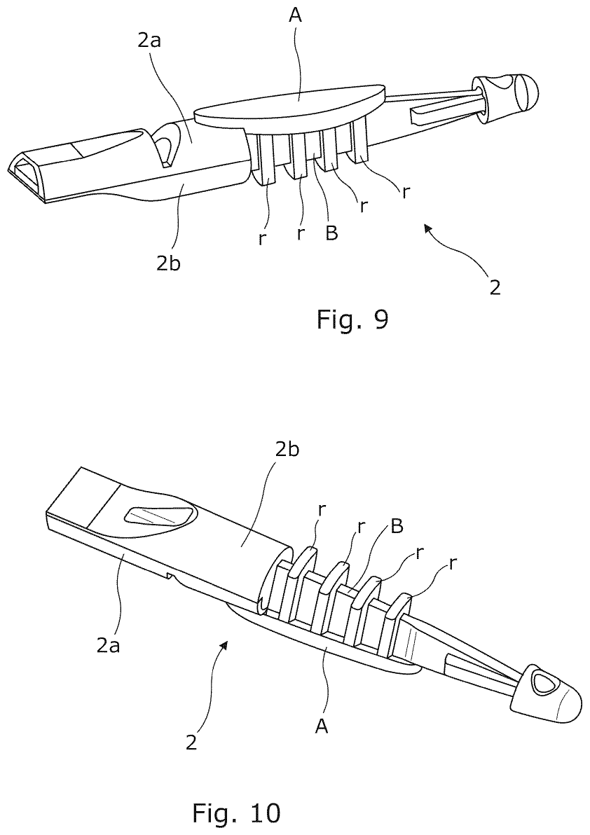

The structure 2 comprises upper and lower polycarbonate components 2a and 2b that are assembled together prior to the coating 3 being applied. The assembled internal structure 2 of the whistle 1 is shown in FIGS. 9 and 10 of the accompanying drawings.

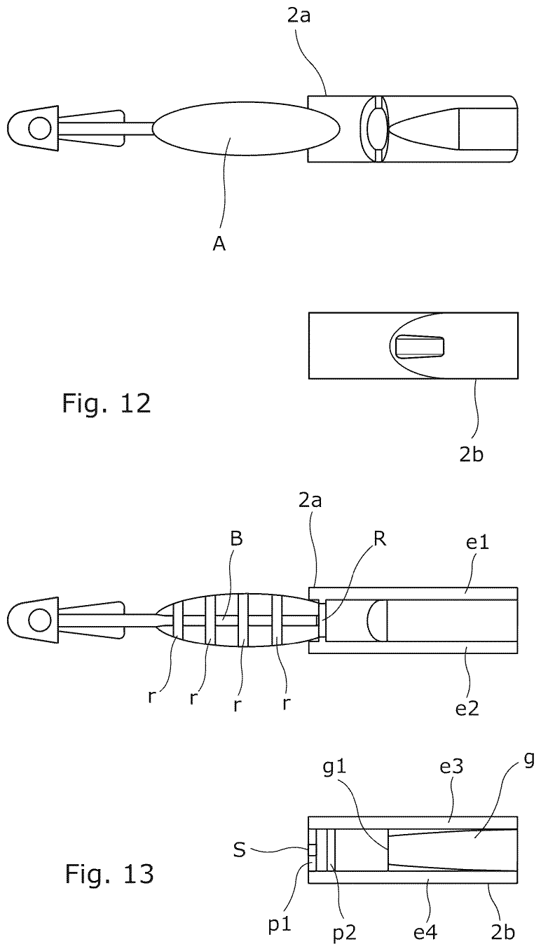

It is to be noted that parts of the internal structure remain exposed in the completed whistle 1 as will be evident by making a comparison between FIG. 1 to 8 and FIGS. 9 to 14.

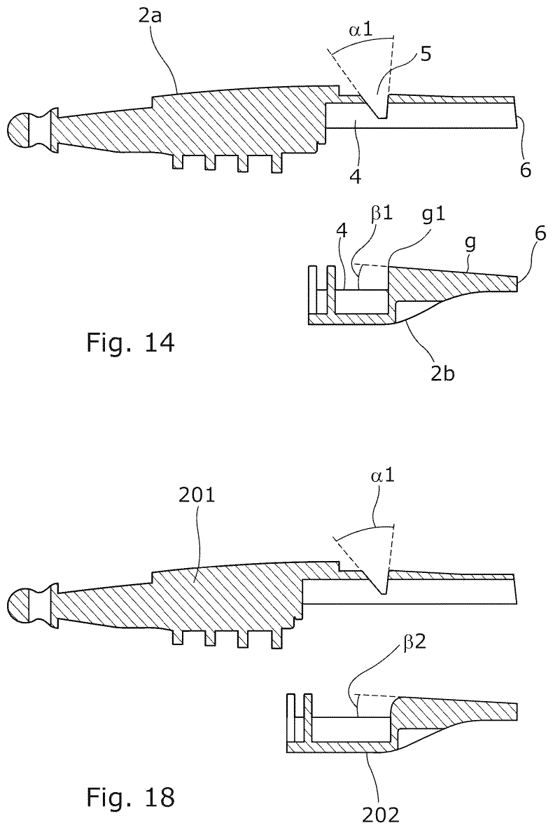

The two component parts 2a and 2b are brought or joined together to define a whistle sound chamber 4 (shown in two parts in FIG. 14) with air vent 5 having a cutting or splitter edge 5a and mouthpiece 6 (shown in two parts in FIG. 14).

It is to be noted that, advantageously, no locating pegs and holes (anchor points) are required to secure the upper and lower component parts 2a, 2b together unlike in the known arrangement of upper and lower component parts (to provide a stable ‘over-mould’) shown in FIGURE A and as shown in Patent Specification No. EP0930605B1 of the Applicant.

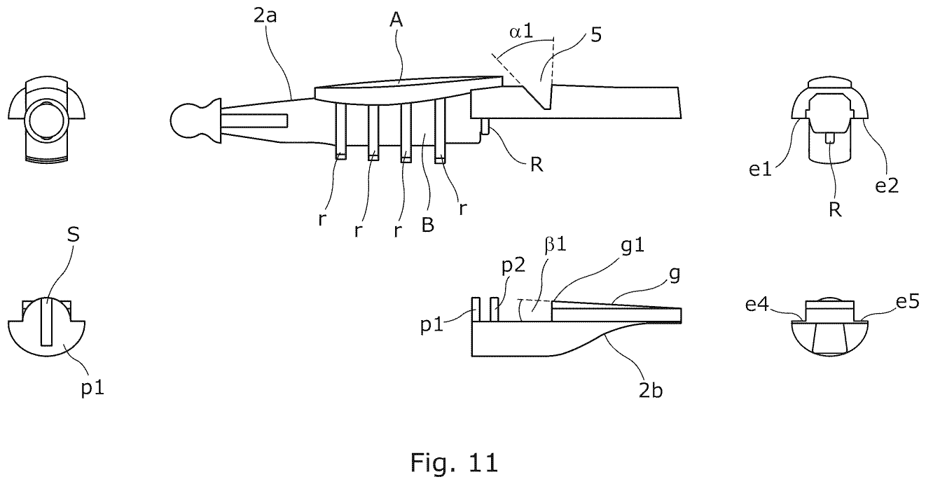

Instead of locating pegs and holes the lower component 2b has two upwardly projecting parallel, part-circular plates p1 and p2 (at a left hand thereof as shown in FIGS. 11 to 14) with plate p1 having a vertical slot S as shown more particularly in the left-hand end view of FIG. 11.

It should be evident that, upon assembly of parts 2a and 2b, a longitudinal or backbone member B of upper component 2a is inserted into slot S as rib plate R on component 2a is introduced and engaged relatively snugly simultaneously in between plates p1 and p2. In this manner, longitudinal edges e1 and e2 of component 2a seat together with edges e3 and e4 on component 2b in contiguous fashion but without any secure, snap-fit locking together of parts 2a,2b.

Advantageously, no adhesive is required to bond the upper and lower components 2a, 2b together. Advantageously, no ultrasonic welding is required to seal the components 2a and 2b together unlike the long-established method of affixing plastics parts together in the art.

Instead of using adhesive or welding the parts 2a, 2b together, rubberised coating 3 is injection moulded onto the assembled framework or structure 2, advantageously, completely sealing the join of sound chamber 4 and the join of the mouthpiece 6. Sealing the join between parts 2a, 2b should prevent any loss of air from the sound chamber and mouthpiece leading to improved efficiency and performance as previously explained earlier in this patent specification. In manufacture of known designs e.g. as shown in FIGURE A ultrasonically welding the two parts 101,102 together along weld line W may result in very small gaps in the weld line sufficient to lower the pressure inside the whistle when blowing, leading possibly to a rejected, non-working whistle. Even a substantially minute gap in the weld line W should be enough to lower the pressure inside the whistle, during blowing, sufficient to alter air flow and adversely affect the sound produced.

The manufacturing process of the present invention, as herein described utilising the rubberised injection moulding coating advantageously provides a chemical and mechanical bond between the upper and lower parts 2a, 2b sealing the join between the two parts eliminating anomalous sounds effects that could otherwise occur.

In the embodiment of the whistle 1 in accordance with the present invention the material of the coating 3 has been selected very carefully to provide a satisfactory bond (both chemical and mechanical bonding) without the need for adhesive or welding.

Most importantly, and advantageously, the coating 3 has been selected and applied in such manner that there is no peeling or tendency for the coating to peel away from the internal framework/structure 2 or tendency for deterioration.

The coating 3 may be of a material identified by the trade mark SANTOPRENE produced by Celanese Materials and being a versatile thermoplastics vulcanizate (TPV) in the thermoplastics elastomer (TPE) family.

The Applicant has painstakingly selected the aforementioned material and applied it an advantageous manner to the framework in such manner as to avoid peeling in the finished whistle. In practice, the whistle 1 is produced in a batch process of injection moulding four frameworks 2 at a time in a moulding tool (not shown) at a temperature of about 200 degrees C.

Overall, the surrounding elastomeric coating offers a much warmer and more comfortable ‘feel’ to the mouth and protection for the teeth unlike the feel associated with the hardened plastics of the mouthpiece of whistle 100. The enhanced and improved mouthpiece design allows a better grip with the mouth and teeth encouraging a better seal with the lips alleviating potential loss or leakage of blown air from around the outer surface of the mouthpiece. The rubberised mouthpiece 6 provides a better grip that is warmer, particularly in cold conditions, and since the coating extends further than the just the mouthpiece, along the length of the whistle 1, handling of the whistle is much warmer and much more comfortable, more particularly in wet or severe weather conditions.

Accordingly, the texture and durability of the coating 3 is important to be conducive to comfortable handing and comfortable blowing.

FIGS. 1 to 8 show five generally transverse, equidistantly spaced, rows 3a of raised elastomeric pips or projections on the underside of whistle 1. These pips/projections 3a are fashioned to enhance a comfortable and more secure grip for the user more particularly in wet weather conditions. The curved ends of four transverse parallel, equidistantly spaced rib plates r on part 2a are exposed in the finished whistle 1 as shown in FIGS. 1 to 8 (and designated by reference numeral 2); rib plate R is hidden from view. The ends of the rib plates r are arranged in between the rows of pips/protusions 3a. In practice, the configuration of rib plates r (rather that a e.g. solid block) allows a more effective and timely flow of injection moulded elastomeric material around framework 2 and out of the mould tooling (not shown). An oval part A of the part 2 is also left exposed in the finished whistle 1 and is suitable for receiving any desirable trade mark or identification e.g. ACME 210 ½ trade marks. It will be evident that other parts of the framework 2 will be exposed in the finished whistle 1.

Accordingly, and advantageously, the outer configuration (general size and dimensions) of the whistle 1 has been adapted to closely approximate/mimic the configuration of the known whistle 100 and to deliver a sound of the same frequency (6200 Hz and having a sound radius of 90m). Therefore, a user should become readily familiar and instantly receptive to whistle 1 which should appear similar but much more warmer/comfortable while not appearing perceptibly deformable or spongy in the mouth.

In the known process of making whistle 100 parts 101 and 102 may become scuffed during the moulding process of the parts. Accordingly, when this happens the parts 101.102 require polishing to remove the scuffs from the finished whistle. Thus, in the advantageous process of the present invention the coating 3b covers any surface of the parts 2a, 2b that may be scuffed eliminating any need for polishing.

Most importantly, and advantageously, the inventor has realised that changes to the angle of the cutting or splitter edge 106 (se FIGURE A) and relationship to the air directing input channel (ramp angle)—not shown in FIGURE A—inside the mouthpiece-should enable escaping air to be eliminated, more particularly at the corners of the cutting or splitter edge 106a.

Furthermore, it has been found that the elastomeric material around the curved top edge of the splitter edge 5a of air vent 5 of whistle 1 has an effect on the air flow that appears to have advantageous effects in the sound produced enhancing the removal of secondary sounds.

Accordingly, it has been realised that an improved sound can be provided in whistle 1—designed to produce a frequency of 6200 Hz—by the adoption of the new angle of the cutting or splitter edge al of 43°+/−3° and air directing input channel (air inlet) i.e. ramp angle β1 of about 4° (see FIGS. 11 and 14).

Whistles of this frequency, although suitable for all dogs, tend to be preferred by dogs such as spaniels.

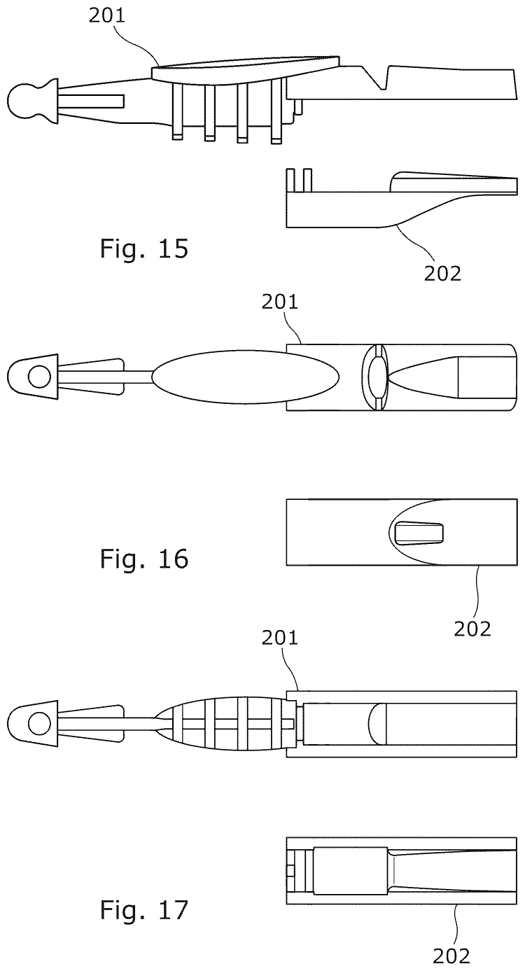

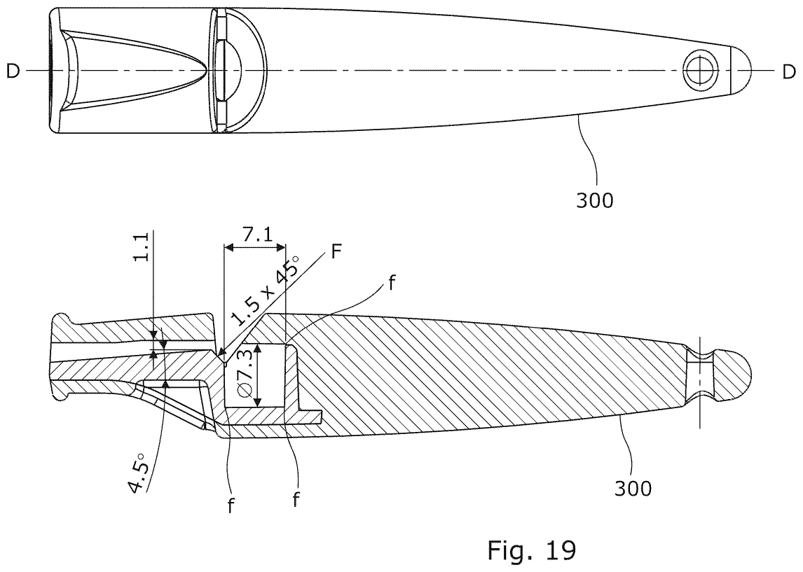

A corner g1 of an inner end of the ramp g may be right-angled as shown more particularly in FIGS. 11,13 and 14, or it could be radiused (see for example FIGS. 15 to 18) or angled/chamfered (example at 45° see e.g. FIG. 19) in order to improve sound quality.

Blowing the 210 ½ ACME whistle 100 shown in FIGURE A will produce a markedly different sound—albeit the same frequency—as whistle 1. Changing the ramp angle to 43° and the splitter edge angle to 4° as in whistle 1 achieves a clearer, crisper and louder sound whilst retaining the all important frequency of 6200 Hz.

Once again as there is substantially no leakage of air from whistle 1, advantageously, whistle commands may be issued to a dog using seemingly minimum effort and breath without production of confusing secondary sounds.

FIGS. 15 to 18 show views of modified upper and lower component parts 201 and 202 of a second embodiment of a whistle accordance with the present invention (having an outer finished configuration substantially as shown in FIGS. 1 to 8 of the drawings)

FIGS. 15 to 18 are similar to FIGS. 11 to 14 although no end views are shown.

A whistle having an outer finished configuration substantially in accordance with FIGS. 1 to 8 but having an internal structure provide by framework 210, 202 is arranged to produce a frequency of 5700 Hz over a sound radius of 1.5 km. This frequency range is identical to the Applicant's ACME 211 ½ whistle. 211 ½ is a Registered Trade Mark (UK 00911570405) of the Applicant.

Whistles of this frequency, although suitable for all dogs, tend to be preferred by dogs such as labradors and retrievers.

Thus, the general method of manufacture is similar to that for whistle 1 except that the configuration of the framework 201, 202 is modified from framework 2a,2b in a manner which should be evident from the FIGS. 15 to 18 of the drawings.

In this case α2 is also 43°+/−3° (rather than 55° as in FIGURE A) and β2 is about 4.5°. Once again, these changed angles in a whistle designed to produce 5700 Hz with the elastomeric coating according to the present invention produce the improved performance already discussed in relation to whistle 1.

Angles α1, of 43°+/−3° and β1 of about 4° could be advantageous and provide an improved performance in the ACME 210 ½ whistle 100 shown in FIGURE A. Even so, the adoption of these angles appears to provide exceptional results with the whistle 1 shown in FIGS. 1 to 8, 9 to 14.

Angles α2 also of 45°+/−3°, and β2 also of about 4.5° could be advantageous and provide an improved performance in the ACME 211 ½ whistle of the Applicant shown on the Applicant's website and of similar exterior appearance to whistle 100 shown in FIGURE A. Even so, the adoption of these angles appears to provide exceptional results with the whistle 1 shown in FIGS. 1 to 8 and FIGS. 9,10,15 to 18.

FIG. 19 shows diagrammatically views a modified version of a 210 ½ whistle 300 (i.e producing a frequency of 6200 Hz).

Accordingly, it is believed that dimensions marked on the sectional view shown in FIG. 19 offer an improved performance over known whistles. In particular, a corner F of the ramp shown in whistle 300 has an angled or chamfered edge of 45°.

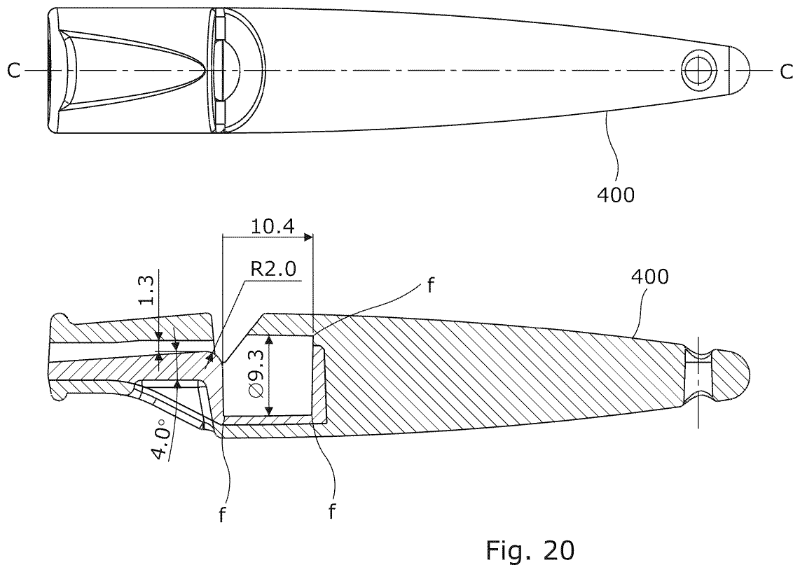

FIG. 20 shows a modified version of a 211 ½ whistle 400 (i.e producing a frequency of 5700 Hz).

Accordingly, it is believed that dimensions marked on the sectional view shown in FIG. 20 offer an improved performance over known whistles.

Further according the present invention there is provided a whistle having one or more of the dimensions marked on FIG. 19 or one or more of the dimensions marked on FIG. 20

FIGS. 21 and 22 show longitudinal sectional views through known whistle 100 shown in FIGURE A of upper component 101 and lower component 102, respectively.

The identical upper component 101 is utilised for the known Applicant 211 ½ whistle coupled with a different lower component (not shown).

The Applicant believes that different design features between the known 210 ½ whistle 100 shown in FIGS. A, 21, 22 and the embodiments of the present invention as herein described are many but the most important differences that make the most significant contribution to performance both in the 210 ½ whistle and 211 ½ whistle in accordance with the present invention are:-
a) The angle α1, α2 of the splitter edge 106 in whistle 1 and in the known 211 ½ whistle is changed from 55° to 43°. This angle was originally 38°. The changed angle of 43°+/−3° applies seemingly equally well to both new rubberised whistles 210 ½ and 211 ½ in accordance with embodiments of the present invention. The provision of the elastomeric coating 3 has an effect on the sound produced and a steeper (more acute) vent angle α1, α2 than 55° creates a better performance (better quality sound) optimised at 43+/−3°.
b) Importantly, the rounded corners c1, c2, c3 (see FIGS. 21 and 22) of the internal (cylindrical) sound chamber of whistle 100 and 210 ½ whistle are now straight or sharp right angles in sectional view (compare with corners f in FIGS. 19 and 20). This helps raise the frequency and loudness of the sound produced.
c) The angle of the air inlet (ramp angle β1, β2) through the mouthpiece preferably, and advantageously, is different for the 210 ½ and 211 ½ whistles.

Preferably, the 211 ½ whistle angle β2 has a variance to the horizontal of 4.5 degrees whilst the 210 ½ whistle has a variance of 4.0 degrees to the horizontal. This selection for vent angle β1, β2 works exceedingly well in conjunction with the internal corner that is a radius (e.g R 2.0 in FIG. 20) on the 211 ½ whistle and a chamfer or flat angle on the 210 ½ (designated F in FIG. 19). The provision of the chamfer F in the whistle 1 is highly important to the sound produced (as is the radius—R2.0—on the 211 ½ whistle). The fundamental frequencies are 6300 Hz on 2111/2 whistle and 5000 Hz on 211 ½ whistle. The chamfer F (or radius—R2.0—) acts as an air director and helps achieve a solid frequency and substantially eliminate air wastage and unrequired frequencies.
d) Chamfer F (and radius R2.0) also helps to control the air flow through the whistle1, 300,400. This is important for controlling the way in which each whistle is blown. The 2111/2 whistle needs to be blown with more pressure and gives a lower continuous note. Whistle 2101/2 (in great contrast) gives a short note that the user can effectively blow into to render the sound extremely quiet. Such a sound may be little more than a quick ‘pip’. Dogs respond extremely well to this way of signalling. The 2101/2 whistle offers the user/blower a resistance that makes the production of the ‘pip’ quite natural.
e) Both 210 ½ and 211 ½ whistles can be exceptionally quiet if blown gently. Most whistles stall or are silent at very low breath pressure but not these whistles.
f) All sounds have a range of frequencies within themselves. The middle octave produces the most important frequencies. In both new 210 ½ and 2111 ½ whistles 1,300,400 in accordance with embodiments of the present invention the number of such frequencies is reduced . The effect of this is a greater quality or timbre of sound. Accordingly, and advantageously, these whistles in accordance with the present invention have a “brighter, sharper” sound. This sound has produced a better response at close working with 210 ½ whistle 1 and has also led to far greater distance response on whistle 211 ½. The known whistle (e.g. FIGS. A, 21, 22) worked best under distances of 500 metres but embodiments of the present invention my also work well at distances of 589 Metres.

It is to be understood that the scope of the present invention is not to be unduly limited by the particular choice of terminology and that a specific term may be replaced or supplemented by an equivalent or generic term. For example, the term ‘coating’ could be replaced by ‘wrapping’; ‘joining’ could be replaced by ‘connecting’; ‘whistle’ could be replaced by ‘wind instrument’ or ‘wind signalling device’; the terms ‘top’, ‘bottom’, and ‘side’, ‘upwardly’ and ‘above’, ‘forward’, may be used to explain possible relative positions of various components of the whistle, in use, and are not intended to be limiting. Further it is to be understood that individual features, method or functions relating to the whistle might be individually patentably inventive. The singular may include the plural and vice versa. Additionally, any range mentioned herein for any parameter or variable shall be taken to include a disclosure of any derivable sub-range within that range or of any particular value of the variable or parameter arranged within, or at an end of, the range or sub-range.

1.-14. (canceled)

15. A whistle comprising component parts brought or joined together to define a whistle sound chamber with an air vent and a mouthpiece, the sound chamber and mouthpiece being substantially covered or coated by an elastomeric material moulded onto the component parts sealing the join or connection between the component parts.

16. The whistle as claimed in claim 15 having two component parts provided to define the sound chamber and mouthpiece.

17. The whistle as claimed in claim 15, wherein the component parts are assembled together to form a structure or framework or skeleton on which the elastomeric material can be injection moulded.

18. The whistle as claimed in claim 17, wherein the two component parts or two of the component parts are assembled together by two projecting plates provided on a first one of said component parts engageable with a plate on the other component part arranged between said first mentioned plates and, preferably, in which the two projecting plates are part-circular and/or in which the two projecting plates are at an end of the sound chamber and, preferably, in which one of said two projecting plates is provided with a slot receiving a longitudinal or backbone member of said other component part and, preferably, in which said other component part is provided with a series of rib plates extending transversely of the backbone member, and, preferably, in which edges of said rib plates are exposed.

19. The whistle as claimed in claim 15, wherein longitudinal edges of a first one of the component parts seats together with edges of an, or the other part in contiguous fashion to define the sound chamber and mouthpiece.

20. The whistle as claimed in claim 15, wherein the seal between the component parts provides a mechanical and/or chemical bonding.

21. The whistle as claimed in claim 15, wherein the elastomeric coating extends substantially along a handling length of the whistle.

22. The whistle as claimed in claim 17, wherein the elastomeric material is non-peelable away from the framework or structure.

23. The whistle as claimed in claim 15, wherein the elastomeric material is configured to have enhanced grip characteristics for handling the whistle and, preferably, in which the elastomeric material is so configured by raised pips/protrusions and, preferably, in which the enhanced grip characteristics are provided on an underside of the whistle.

24. The whistle as claimed in claim 15, wherein the angle of a cutting or splitter edge of the air vent is 43°+/−3°.

25. The whistle as claimed in claim 15, wherein the angle of an air inlet of the whistle is about 4° and, preferably, in which the air inlet is an air directing channel or ramp and, preferably, in which a corner of an inner end of the ramp or channel is right-angled, radiused or angled (example at 45°).

26. A method of making a whistle comprising bringing or joining together component parts to define a whistle sound chamber with an air vent and a mouthpiece and substantially covering or coating the sound chamber and mouthpiece by an elastomeric material moulded onto the component parts sealing the join or connection between the component parts.
